(19) United States
(12) Patent Application Publication
(10) Pub. No.: US 2007/0223122 A1
(43) Pub. Date: Sep. 27, 2007

(54) Data recovery method

(75) Inventor: Yoshinori Kadowaki, Higashine (JP)

Correspondence Address: KRATZ, QUINTOS & HANSON, LLP, 1420 K Street, N.W., Suite 400, WASHINGTON, DC, 20005, US

(73) Assignee: FUJITSU LIMITED, Kawasaki (JP)

(21) Appl. No.: 11/473,040

(22) Filed: Jun. 23, 2006

(30) Foreign Application Priority Data
Mar. 27, 2006 (JP) 2006-086535

(51) Int. Cl. G11B 5/02; G11B 27/36; G11B 5/596

(52) U.S. Cl. 360/25; 360/31; 360/78.06

(57) ABSTRACT

A data recovery method for detecting information recorded on a recording surface of an information recording medium, comprising the step of: moving a reproduction head on the recording surface of the information recording medium, wherein, in the moving step, the reproduction head is moved on the recording surface of the information recording medium at such a velocity that a state of the recording surface of the information recording medium is not affected.

### BACKGROUND OF THE INVENTION

1. Field of the Invention

The present invention relates to a data recovery method.

2. Description of the Related Art

In a hard disk drive as one example of an information recording/reproduction apparatus, when a so-called head crash occurs, smoothness of a magnetic film surface of a magnetic disk recording medium may be lost, and thus, it may become difficult to reproduce information from the magnetic disk recording medium by means of a standard reproducing manner.

Then, when the standard reproducing manner is applied even to the magnetic disk recording medium having such a condition, a reproduction head itself may be damaged when accessing to the magnetic disk recording medium, or the magnetic film may be further damaged.

In such a case, in order to read information, which is magnetically recorded on the magnetic disk recording medium, which has been damaged due to the head crash or such, one way is to carry out re-smoothing of the damaged magnetic film surface, for example. It is noted that such processing carried out for reading information originally recorded on a recording medium such as the magnetic disk recording medium, which has been thus damaged due to the head crash or such, is called ‘data recovery’.

By thus carrying out the re-smoothing, reproduction of the recorded information from areas other than the actually damaged area is made possible. However, the re-smoothing requires a large working quantity, and thus, it requires long time in pre-processing required before actually carrying out the operation of reading the information from the damaged recording medium. Further, in this case, an area for which re-smoothing has not been made sufficient may be left even after the smoothing processing has been carried out. If so, the reproduction head device may be damaged during the data recovery process. Accordingly, spare head devices should be prepared therefor.

Thus, much time and expenses tend to be required for carrying out the data recovery from the damaged recording medium, which has been damaged due to the head crash or such. Further, since it may not be possible to thoroughly carry out the re-smoothing as mentioned above, head crash may again occurs during the data recovery process at the worst case. If so, the data recovery for the recorded information may become further difficult.

The following documents disclose the related arts:

“Drive-Independent Data Recovery: The Current State-of Art”, The magnetic Recording Conference, IEEE, Stafford University, CA, Aug. 15-17, 2005, Charles H. Sobey, Laslo Orto, Glenn Sakaguchi;

“Recovering Unrecoverable Data”, A Channel Science White Paper, Charles H. Sobey, Apr. 14, 2004;

“Secure Deletion of Data from Magnetic and Solid-State Memory”, Sixth USENIX Security Symposium, Peter Gutmann, Department of Computer Science, University of Auckland; and

“Ontrack Data Recovery”, http://www.ontrack-japan.com/,Jan. 30, 2006.

### SUMMARY OF THE INVENTION

The present invention has been devised in consideration of the above-mentioned problem, and an object of the present invention is to provide a method for positively carrying out data recovery from a recording medium damaged by head crash or such, in a relatively simple way.

In order to achieve the object, according to the present invention, a reproduction head is moved at such a speed that a state of a recording medium is not affected, when information recorded on the recording medium is detected by means of the reproduction head moved on the recording medium from which data recovery is made.

By thus moving the reproduction head on the recording surface of the recording medium damaged due to head crash or such at a sufficiently low speed, the information recorded on the recording surface can be positively detected.

Further, by moving the reproduction head on the recording surface of the recording medium at such a sufficiently low speed, it is possible to positively avoid further degradation of the damaged state of the recording surface of the recording medium damaged due to head crash or such.

Thus, according to the present invention, when carrying out data recovery from a recording medium damaged due to head crash or such, information recorded on the recording medium is detected as a result a reproduction head being moved on the recording medium at a sufficiently low speed. At this time, re-smoothing processing of the recording surface of the damaged recording medium should not be carried out previously, or, the same should be carried out only in a simplified manner.

As a result, it is possible to eliminate, or remarkably reduce a working quantity and time, which would be otherwise required much for the re-smoothing processing. As a result, expenses required for carrying out the data recovery from the recording medium damaged due to head crash or such can be effectively reduced.

### BRIEF DESCRIPTION OF THE DRAWINGS

Other objects and further features of the present invention will become more apparent from the following detailed description when read in conjunction with the accompanying drawings:

FIG. 1 shows a perspective view of a mechanism part of one example of a hard disk drive for which a magnetic disk data recovery method according to one embodiment of the present invention is applicable;

FIG. 2 shows a control block diagram of the above-mentioned hard disk drive for which the magnetic disk data recovery method according to the embodiment of the present invention is applicable;

FIG. 3 shows a flow chart illustrating the magnetic disk data recovery method according to the embodiment of the present invention;

FIG. 4 shows a waveform diagram of one example of a signal read out by means of a reproduction head, according to the magnetic disk data recovery method in the embodiment of the present invention;

FIG. 5 shows a waveform of one example of a signal obtained after waveform conversion of the signal shown in FIG. 4;

FIG. 6 shows a waveform of another example of a signal obtained after the waveform conversion of the signal shown in FIG. 4;

FIGS. 7 and 8 show a block diagram illustrating a processing flow of the magnetic disk data recovery method according to the embodiment of the present invention; and

FIG. 9 illustrates one example of an apparatus configuration for carrying out the magnetic disk data recovery method according to the embodiment of the present invention.

### DETAILED DESCRIPTION OF THE PREFERRED EMBODIMENT

In an embodiment of the present invention, a magnetic disk recording medium which is a data recovery target is rotated at a sufficiently low speed, and information recorded is read out from a recording surface of the magnetic disk recording medium. Then, the thus-read information is rewritten into an information signal having timing corresponding to a standard rotation speed of a magnetic recording/reproduction apparatus, i.e., a hard disk drive, in which the magnetic disk recording medium is originally loaded.

Then, on the thus-obtained information, predetermined signal processing is carried out by means of a read channel (referred to as RDC, hereinafter) of the magnetic recording/reproduction apparatus, and thus, data recovery from the magnetic disk recording medium is achieved.

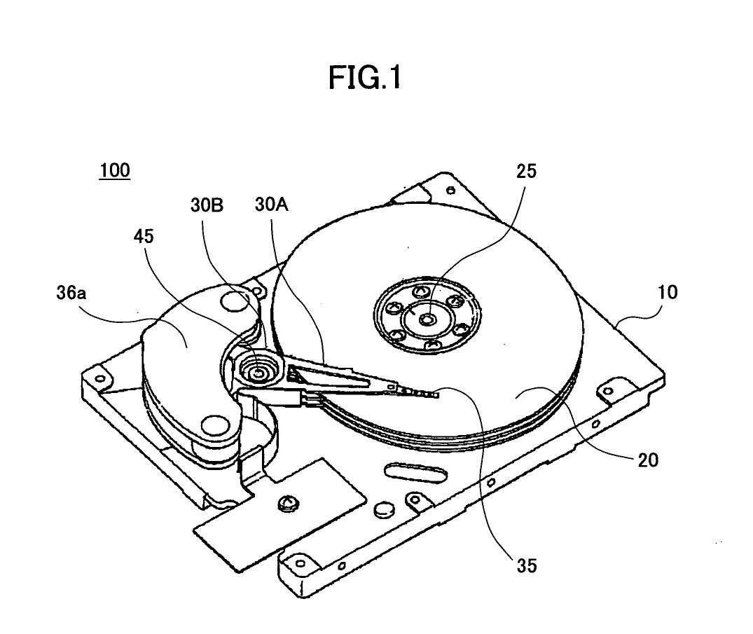

FIG. 1 shows a perspective view of the hard disk drive for which a magnetic disk data recovery method in the embodiment of the present invention is applied.

As shown in FIG. 1, in a mechanism part of the hard disk drive, a plurality of (in this example, three) magnetic disks 20 are integrally fixed to a rotor of a spindle motor 25. By means of the spindle motor, 25, the magnetic disks 20 are integrally rotated at a high speed.

Magnetic heads 35 are provided on suspensions provided at extending ends of respective actuator arms 30A extending outward from an actuator block 30B. Then, when the magnetic disks 20 are rotated at the high speed as mentioned above, air flows generated on the disk surfaces cause the respective magnetic heads 35 to float on the respective disk surfaces with slight gaps. In this head floating state, the magnetic heads 35 magnetically write information to the respective ones of the disk surfaces of the magnetic disks 20 on which the respective magnetic heads face, or magnetically read the recorded information therefrom in the same manner.

The actuator block 30B is rotatably supported by a pivot shaft 45, and, as a result of being driven by a voice coil motor, it drives the magnetic heads 35 provided on the suspensions at the extending ends of the head arms 30A, so that the magnetic heads 35 are positioned at desired cylinder positions on the respective ones of the magnetic disks 20. Thus, so-called seek operation is carried out.

For this purpose, the actuator block 30B is driven by a magnetic circuit called the voice coil motor. The voice coil motor includes a yoke 36a and a magnet (not shown) fixed to a disk enclosure 10. Further, it includes a voice coil 38 provided to the actuator block 30B. The voice coil motor drives the actuator block 30B with electromagnetic force under the control of a hard disk controller (HDC) described later.

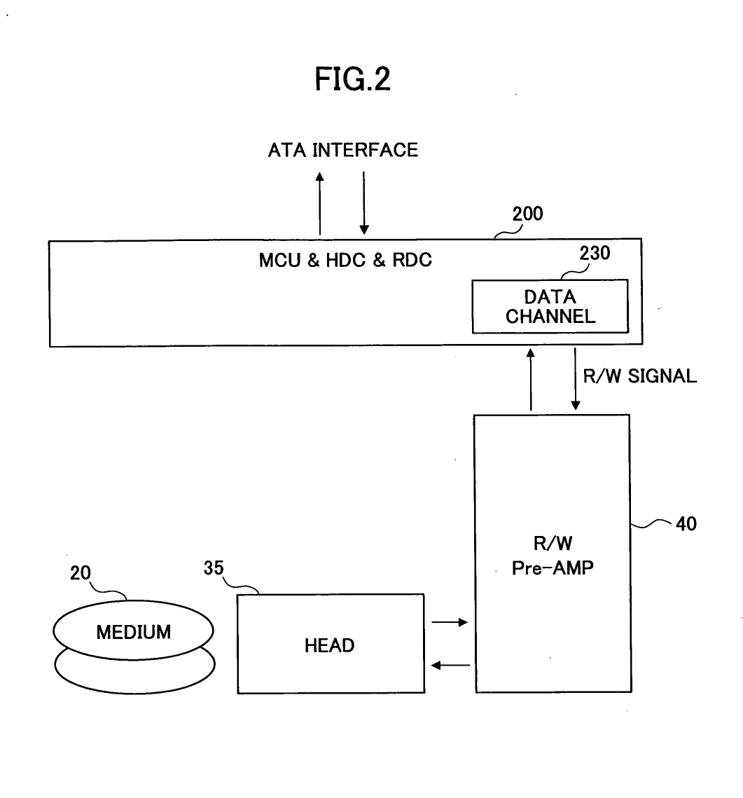

FIG. 2 shows a block diagram illustrating a control function part of the hard disk drive having the mechanism part described above with reference to FIG. 1.

As shown in FIG. 2, in the control function part of the hard disk drive, for information reproduction from the magnetic disks 20, a signal detected by the magnetic head 35 from the magnetic disk 20 is amplified by a pre-amplifier 40 into a read signal, which is then transmitted to a data channel circuit 230. Further, predetermined signal processing is carried out on this signal by the hard disk controller (HDC) and RDC circuit 200. After that, by means of an ATA (advanced technology attachment) interface, the signal is transmitted to a mother board of a personal computer or such, for example.

When a mechanical vibration, impact or such is applied to the hard disk drive having a configuration such as that shown in FIG. 1 by some cause, the magnetic head 35 which floats on the disk surface of the magnetic disk 20 thanks to the air flow generated there as mentioned above and carries out information recording/reproduction operation may come into contact with the disk surface which the magnetic head faces. Then, when kinetic energy thus generated between the magnetic head 35 and the disk surface of the magnetic disk 20 exceeds a certain amount, the magnetic head 35 may damage the disk surface (which may be referred to as ‘recording surface’, hereinafter) of the magnetic disk 20 which rotates at the high speed as mentioned above.

In general, in such a hard disk drive, proper magnetic information writing to/reading from a magnetic disk by means of a magnetic head can be kept with a high accuracy as a result of a slight distance/gap between the magnetic disk and the magnetic head being maintained with a high accuracy. Therefore, when the smoothness of the recording surface of the magnetic disk 20 is lost as a result of the recording surface being damaged as mentioned above, it may not be possible to keep the above-mentioned slight distance/gap between the magnetic head 35 and the magnetic disk 20 with a high accuracy. As a result, proper reproduction operation cannot be ensured. Such a circumstance which causes the recording surface of the magnetic disk to be damaged seriously by the magnetic head may be called ‘head crash’.

When the head crash occurs and the recording surface of the magnetic disk is damaged accordingly, not only difficulty in the proper reproduction operation but also further serious circumstance may occur. That is, when the magnetic head again comes into contact with the damaged part of the recording surface of the magnetic disk, the damaged state of this part of the recording surface may become worse. Thus, the hard disk drive in which the head crash has thus occurred cannot be used in this condition, and should be brought into a manufacture or such for repairing.

On such an occasion, in the related art, as mentioned above, so-called ‘re-smoothing’ processing is carried out, the smoothness of the recording surface of the magnetic disk is thus restored, and thus, proper reproduction operation is made possible. However, in general, a very large quantity of work is required for the ‘re-smoothing’ processing, and thus, time and expenses required for the data recovery from such a hard disk drive having head crash damage, may run into large amounts.

According to the embodiment of the present invention, data recovery from such a hard disk drive having head crash damage can be achieved without re-smoothing processing or with a simplified version of re-smoothing processing.

In the embodiment of the present invention, on the occasion of data recovery from a magnetic disk having its recording surface damaged due to head crash or such, a rotation speed of the magnetic disk is made sufficiently low so that, even when a head device of a reproduction head comes into contact with the damaged part of the recording surface of the magnetic disk, the damaged state is prevented from becoming worse. Specifically, the rotation speed should be very low, i.e., not more than 10 rpm, for example.

As a result of the recording medium being rotated at such a very low speed, a relative velocity between the reproduction head and the recording medium can be lowered sufficiently. As a result, friction energy generated therebetween can be sufficiently reduced, so that damage of the reproduction head, an increase in the damage of the recording surface of the magnetic disk, and so forth, can be effectively avoided.

In the present embodiment, as the reproduction head, a well-known MR (magneto resistive) head is used for detecting information magnetically recorded on the recording surface of the damaged magnetic disk.

A reason why the MR head is used is as follows:

A common reproduction head, i.e., the magnetic head 35 of the common hard disk drive described above with reference to FIGS. 1 and 2, is one called an inductive head. When the inductive head is used for information reproduction from a magnetic disk, reproduced output from the magnetic disk depends on a moving speed of the reproduction head with respect to the recording surface of the magnetic disk. That is, a desired detection output is obtained when the magnetic disk is rotated at a standard high speed, i.e., thousands of rpm, for example. If the common inductive head is used as the reproduction head and detection of the information magnetically recorded on the recording surface of the damaged magnetic disk is tried in a condition in which, as mentioned above, the magnetic disk is rotated at the very low speed, i.e., not more than 10 rpm for example, the desired detection output cannot be obtained accordingly.

The above-mentioned MR head is different from the common inductive head, and is configured to directly detect a magnetic flux density, and thus, it has detection characteristics not depending on the relative velocity. Accordingly, even when the magnetic disk is rotated at the very slow speed, i.e., not more than 10 rpm, for example, the desired detection output can be obtained.

It is noted that, a GMR (giant MR) head, a TUMR (tunnel MR) head, or such, may be employed instead of the MR head, and the same result can be obtained therefrom.

Thus, in the embodiment of the present invention, as the above-mentioned reproduction head, the reproduction head having the configuration such that the information detection sensitivity does not depend on a moving velocity of the reproduction head with respect to the recording medium is employed. Specifically, the above-mentioned MR head, GMR head, TuMR head, or such, is employed.

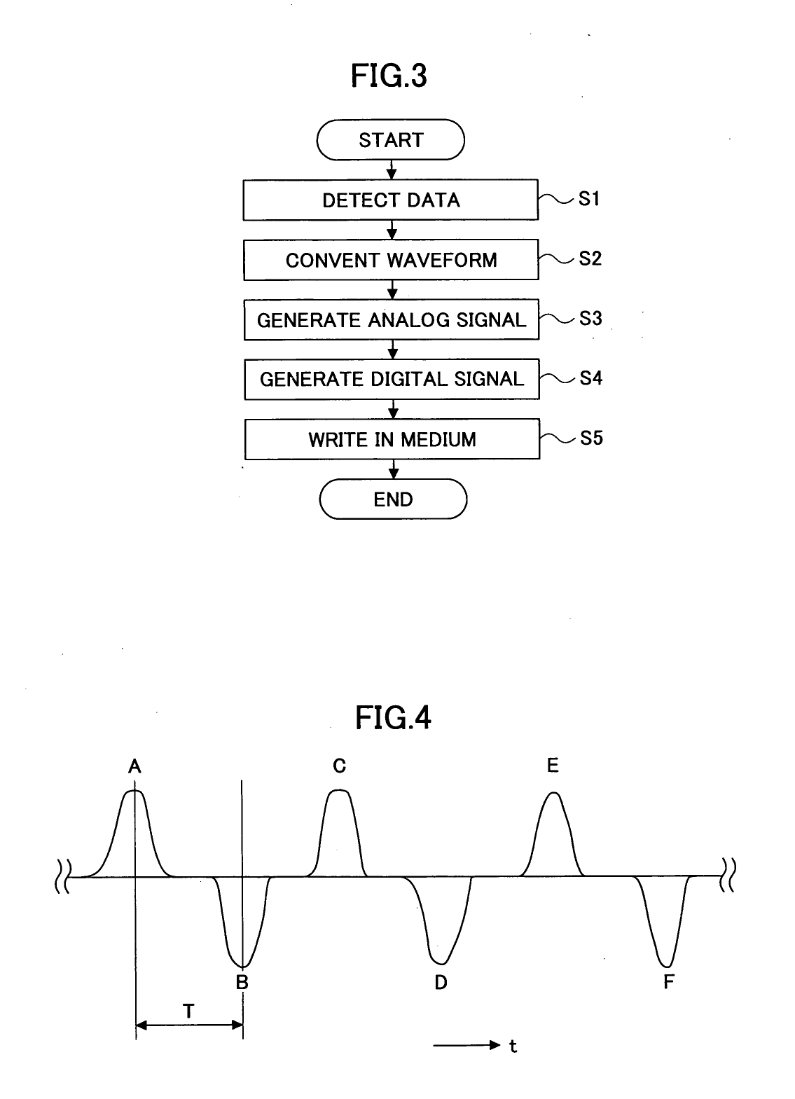

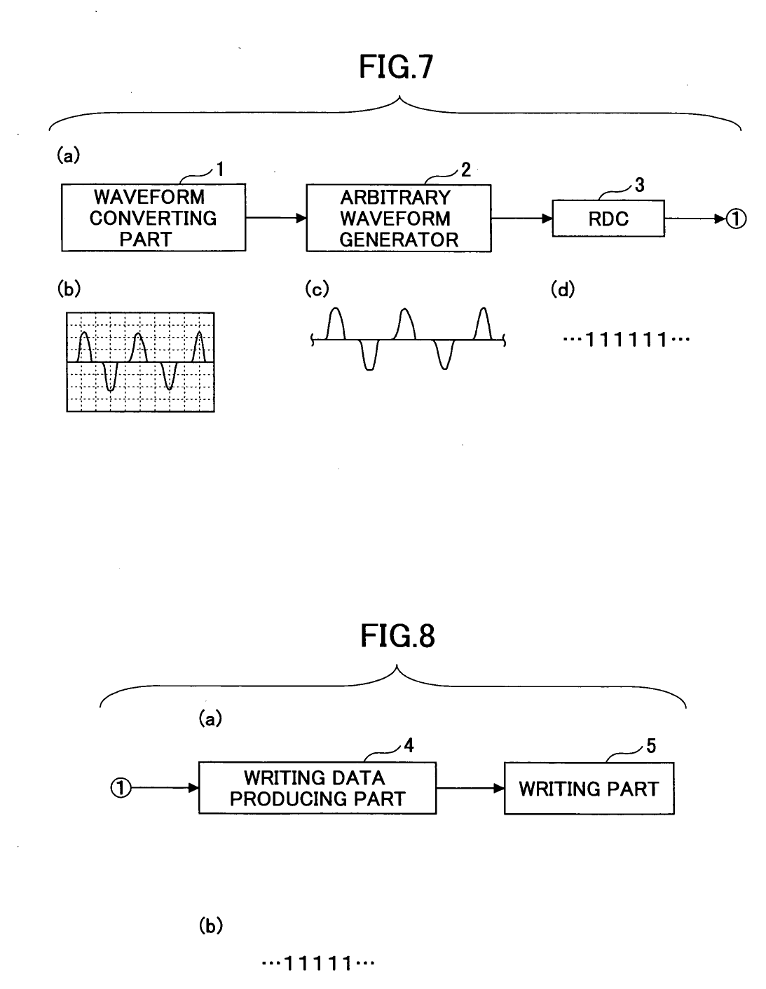

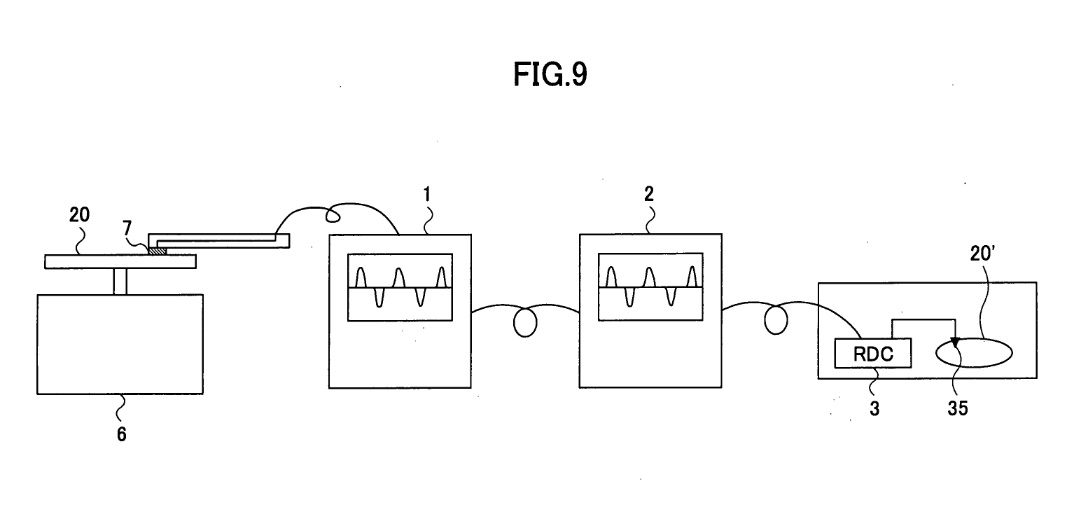

FIG. 3 shows a processing flow chart of the magnetic disk data recovery method in the embodiment of the present invention, and FIGS. 4 through 8 show block diagrams and waveform diagrams for illustrating the processing flow thereof. FIG. 9 shows an example of an apparatus arrangement applied there.

As shown in FIG. 9, as mentioned above, the magnetic disk 20 which is the data recovery target is rotated at the very slow speed (referred to as X rpm, hereinafter), i.e., not more than 10 rpm, and, on the recording surface of the magnetic disk 20, the MR head 7 as the reproduction head is made to slide, whereby the information magnetically recorded on the recording surface is detected (Step S1). FIG. 4 shows an example of a waveform of the detected signal. It is noted that a standard rotation speed (for example, thousands of rpm, as mentioned above) of the hard disk drive in which the magnetic disk which is the data recovery target is originally loaded is referred to as x rpm.

Actual implementation of such a very low rotation speed of the magnetic disk is not possible in a common hard disk drive such as that described above with reference to FIGS. 1 and 2. Therefore, in the present embodiment, the damaged magnetic disk 20 is once removed from the hard disk drive, and is loaded in a driving apparatus 6 specially designed for stably rotating such a magnetic disk at the above-mentioned very low rotation speed, i.e., X rpm. After that, actual data recovery processing is carried out therefrom.

Further, in prior to the actual operation of detecting the recorded information in the above-mentioned Step S1, re-smoothing processing may be carried out, if necessary, on the magnetic disk 20 which is the data recovery target, so as to re-smooth the damaged recording surface of the magnetic disk 20. This re-smoothing processing may be carried out for the purpose of restoring the smoothness of the recording surface of the magnetic disk 20 for which the smoothness has been lost as a result of the damage of the recording surface occurring due to head crash or such. In this re-smoothing processing, well-known art may be applied. For example, grinding/polishing processing, cleaning processing, coating processing, or such, may be applied. However, in the present embodiment, a relative velocity between the reproduction head 7 and the magnetic disk 20 is sufficiently low as a result of the magnetic disk 20 being rotated at the very slow speed, i.e., X rpm as mentioned above, whereby the friction energy generated therebetween is reduced as much as possible. Accordingly, the re-smoothing processing, which may be carried out if necessary as mentioned above before the actual information detecting operation, may be of a simplified version. This is because, even when the smoothness of the recording surface of the magnetic disk is restored not completely thereby, a problematic situation in which the MR head 7 is damaged or the damaged state of the recording surface of the magnetic disk 20 becomes worse, can be positively avoided thanks to the above-mentioned sufficiently low rotation speed of the magnetic disk 20.

The description of the processing flow with reference to FIG. 3 is returned to. The detection output of the information magnetically recorded on the recording surface of the magnetic disk 20, which is the data recovery target, is then input to a commercially available digital oscilloscope 1, and is once stored there. In the present embodiment, as one example of the digital oscilloscope 1, a ‘digital oscilloscope’, type: DP07254, made by Tektronix Japan, Ltd., is used. However, it is not necessary to limit to this example. Any other type of an AD (analog-to-digital) converter having a function of digitalization from data detected by the MR head 7 may be used instead.

Then, a temporal axis of a signal waveform, such as that shown in FIG. 4, of the detection output signal from the damaged magnetic disk 20, which is the data recovery target, which has been stored in a memory of the digital oscilloscope 1 after the detection from the magnetic disk 20 as mentioned above with the use of the function of the digital oscilloscope, is compressed by a ratio of X:x (Step S2).

That is, as mentioned above, the detection output signal thus obtained from the damaged magnetic disk 20 which is the data recovery target is one detected at the sufficiently low rotation speed of the magnetic disk 20, i.e., X rpm, which is sufficiently lower than the standard rotation speed x rpm of the magnetic disk 20 as mentioned above. Accordingly, it is necessary to convert the signal waveform of the detection output signal into a signal waveform of clock timing, which would be obtained when the magnetic disk 20 is rotated at the standard rotation speed x rpm. For this purpose, the processing of compressing the temporal axis of the signal waveform of the detection output signal is carried out at a compression rate of the ratio between the detecting rotation speed X rpm and the standard rotation speed x rpm.

A well-known art may be applied for the compressing of the temporal axis of the signal waveform. That is, for example, the detection signal is once written in a memory with a clock signal of a clock frequency (period: T) corresponding to X rpm; and after that, the written data is read with a clock signal of a clock frequency (period: t) corresponding to x rpm. For such signal processing for carrying out waveform conversion to compress the temporal axis of the signal waveform, a signal processing apparatus may be specially prepared other than an AD converter such as the digital oscilloscope.

As a result, the signal period (clock period) T seconds in the state of FIG. 4 is changed into t seconds, as shown in FIG. 5. There, T:t=x:X.

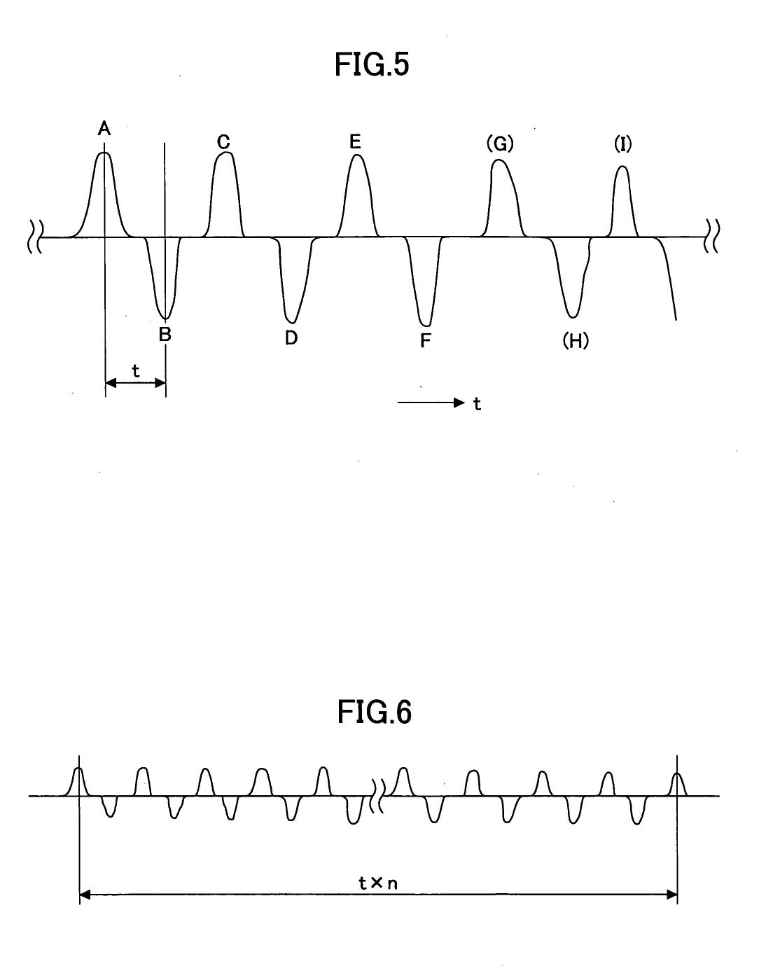

It is noted that, the signal conversion may be carried out bit by bit, or, for example, as shown in FIG. 6, the waveform conversion may be carried out for a unit of 256 bits or 512 bis (=t×n) in a lump. Thereby, it is possible to improve the signal processing efficiency.

The detection signal thus obtained in a form of numeric data converted into the waveform of the clock timing corresponding to the standard rotation speed of the magnetic disk 20, which is the data recovery target, is then input to an arbitrary waveform generator 2, whereby the detection signal is then converted into a corresponding analog signal (Step S4). In the present embodiment, as this arbitrary waveform generator 2, ‘Function Generator’, of type: 1281, made by TOYO Corporation, is used. However, it is not necessary to limit to this example. Instead, a common DA (digital-to-analog) converter may be used.

Further, the thus-obtained detection signal as an analog signal is then input to the RDC 3 (MCU & HDC & RDC 200 shown in FIG. 2) of the hard disk drive, in which the magnetic disk 20, which is the data recovery target, is originally loaded. Then, by means of a data modulation function of the RDC 3, the detection signal is binarized. That is, whether the detection signal corresponds to ‘0’ or ‘1’ is determined at predetermined timing (Step S4).

Further, the thus-obtained read information from the magnetic disk 20, which is the data recovery target, may be then written in a magnetic disk 20′, which is not damaged, loaded in the above-mentioned hard disk drive (Step S5). In this case, by means of the function of the above-mentioned MCU & HDC & RDC 200 shown in FIG. 2 (corresponding to a writing data generating part 4 of FIG. 8), writing data is generated from the above-mentioned binarized data of the detection signal. Then, the thus-obtained data signal is amplified by means of the pre-amplifier 40 (corresponding to a writing part 5 of FIG. 8), and after that, the data is written in the above-mentioned magnetic disk 20′ in a standard recording operation by means of the magnetic head 35 (included in the writing part 5 of FIG. 8).

Thus, according to the embodiment of the present invention, the MR head slides, at the very low relative speed, on the recording surface of the magnetic disk having the recording surface damaged, and the information magnetically recorded on the recording surface of the magnetic disk, which is the data recovery target, is detected. Accordingly, it is possible to detect the information magnetically recorded on the recording surface of the magnetic disk, which is the data recovery target, effectively and positively, even with such a relatively simplified manner.

As a result, it is possible to effectively reduce the work quantity and the time which would be otherwise required for when the re-smoothing processing in the complete version (for achieving the complete restoration of the smoothness) were carried out, by omitting or simplifying the re-smoothing processing. Accordingly, it is possible to effectively reduce the expenses required for the data recovery. Further, it is possible to effectively reduce a risk that the reproduction head would be damaged, the damage of the recording surface of the magnetic disk which is the data recovery target would become worse, or such.

Application of the present invention is not limited to a magnetic disk apparatus such as the hard disk drive. The present invention may be applied to a wide variety of recording/reproducing apparatuses having a configuration such that information is recorded in or reproduced from a recording medium which is rotated at a high speed, i.e., various disk drives for CD, DVD, and so forth.

Further, the present invention is not limited to the above-described embodiment, and variations and modifications may be made without departing from the basic concept of the present invention claimed below.

The present application is based on Japanese Priority Application No. 2006-086535, filed on Mar. 27, 2006, the entire contents of which are hereby incorporated herein by reference.

What is claimed is:

1. A data recovery method for detecting information recorded on a recording surface of an information recording medium, comprising the step of:
relatively moving a reproduction head on said recording surface of said information recording medium, wherein:
in said moving step, said reproduction head is relatively moved on said recording surface of said information recording medium at such a velocity that a state of said recording surface of said information recording medium is not affected.

2. The data recovery method as claimed in claim 1, wherein:
as said reproduction head, one having such a configuration that information detection sensitivity thereof does not depend on the moving velocity of said reproduction head is used.

3. The data recovery method as claimed in claim 1, wherein:
in said moving step, said reproduction head relatively slides on said recording surface of said information recording medium at such a velocity that a state of said recording surface of said information recording medium is not affected.

4. The data recovery method as claimed in claim 1, wherein:
in said moving step, a relative velocity of said reproduction head on said recording surface of said information recording medium corresponds to equal to or less than 10 rpm in the rotation speed of said information recording medium.

5. The data recovery method as claimed in claim 3, wherein:
in said moving step, a relative velocity of said reproduction head on said recording surface of said information recording medium corresponds to equal to or less than 10 rpm in the rotation speed of said information recording medium.

6. The data recovery method as claimed in claim 1, further comprising the step of:
converting a waveform of a detection signal obtained from moving said reproduction head on said recording surface of said information recording medium, to obtain a waveform equivalent to one which would be obtained when detection was made from said information recording medium at a standard information reproduction head relatively moving velocity.

7. The data recovery method as claimed in claim 3, further comprising the step of:
converting a waveform of a detection signal obtained from moving said reproduction head on said recording surface of said information recording medium, to obtain a waveform equivalent to one which would be obtained when detection was made from said information recording medium at a standard information reproduction head relatively moving velocity.

8. The data recovery method as claimed in claim 6, wherein:
in said waveform converting step, an analog-to-digital converter is employed for converting a detection waveform obtained with the use of the reproduction head, into a digital signal.

9. The data recovery method as claimed in claim 7, wherein:
in said waveform converting step, an analog-to-digital converter is employed for converting a detection waveform obtained with the use of the reproduction head, into a digital signal.

10. The data recovery method as claimed in claim 8, wherein:
said analog-to-digital converter comprises a digital oscilloscope.

11. The data recovery method as claimed in claim 9, wherein:
said analog-to-digital converter comprises a digital oscilloscope.

12. The data recovery method as claimed in claim 8, further comprising the step of:
converting numerical data obtained from said waveform converting step into an analog signal with the use of a digital-to-analog converter.

13. The data recovery method as claimed in claim 9, further comprising the step of:
converting numerical data obtained from said waveform converting step into an analog signal with the use of a digital-to-analog converter.

14. The data recovery method as claimed in claim 12, wherein:
said digital-to-analog converter comprises an arbitrary waveform generator.

15. The data recovery method as claimed in claim 13, wherein:
said digital-to-analog converter comprises an arbitrary waveform generator.

16. The data recovery method as claimed in claim 1, further comprising the step of:
converting the detection information into a digital signal with the use of a read channel.

17. The data recovery method as claimed in claim 1, further comprising the step of:
smoothing said recording surface of said information recording medium before said step of relatively moving said reproduction head on said recording surface of said information recording medium.

18. The data recovery method as claimed in claim 3, further comprising the step of:
smoothing said recording surface of said information recording medium before said step of said reproduction head relatively sliding on said recording surface of said information recording medium.

19. The data recovery method as claimed in claim 1, wherein:
said information recording medium comprises a magnetic disk information recording medium.
